(19) United States
(12) Patent Application Publication
(10) Pub. No.: US 2021/0378233 A1
(43) Pub. Date: Dec. 9, 2021

(54) GAME COLLECTION AND RETENTION SYSTEM AND APPARATUS

(71) Applicant: JORDAN ANTHONY SALPIETRA, (US)

(72) Inventors: JORDAN ANTHONY SALPIETRA, DALLAS, TX (US); BRANDON SHANE CLINE, PEARSALL, TX (US)

(73) Assignee: JORDAN ANTHONY SALPIETRA, DALLAS, TX (US)

(21) Appl. No.: 17/092,318

(22) Filed: Nov. 8, 2020

Related U.S. Application Data
(63) Continuation-in-part of application No. 29/712,364, filed on Nov. 7, 2019, now Pat. No. D913409.

(51) Int. Cl. A01M 31/00

(52) U.S. Cl. CPC A01M 31/006

(57) ABSTRACT

A game collection and retention apparatus includes a pole and a first plate. The pole includes a stabilizing portion and a support portion, wherein the stabilizing portion is configured to stabilize the game collection and retention apparatus in a substantially upright position. The first plate is positioned along the support portion of the pole and includes comprising a plurality of teeth around a perimeter thereof, wherein the plurality of teeth at least partially define one or more notches.

### RELATED APPLICATION

This application is a continuation-in-part of pending U.S. Design patent application Ser. No. 29/712,364 entitled “Hunting Game Carrier,” which was filed on Nov. 7, 2019.

### TECHNICAL FIELD

This disclosure relates in general to game hunting and more particularly to a game collection and retention system and apparatus.

### BACKGROUND

Outdoorsmen such as hunters and fishermen are generally restricted, by federal or state regulation, in the capacity of wild game that they may kill, keep, and/or control. One such regulation is a “bag limit” which refers to a maximum amount of animals of a specific species that may be killed (or otherwise taken) by a single outdoorsman within a particular period (e.g., day, season). As an example, the bag limit for dove in Texas during the 2019-2020 dove season was 15 per day. Bag limits for different types of species may vary widely. For example, during the 2019-2020 season, the Texas bag limit for whitetail deer was 5 per season whereas the Texas bag limit for duck was 6 per day. Bag limits may also vary geographically. As an example, the daily bag limit for dove in Hawaii during the 2019-2020 season was 10 in comparison to the Texas limit of 15 per day.

Violations of bag limit rules and regulations may result in penalties imposed by state and/or federal agencies. Accordingly, outdoorsmen are incentivized to monitor their “takes” to comply with bag limits. Such monitoring is conventionally performed by recording and/or keeping a mental count.

### SUMMARY OF THE DISCLOSURE

According to one embodiment, a game collection and retention apparatus includes a pole, a first plate, a second plate, and a third plate. The pole includes a stabilizing portion and a support portion, wherein: each of the stabilizing portion and the support portion comprises a first end and a second end; the first end of the stabilizing portion is configured to couple to the second end of the support portion; and the second end of the stabilizing portion is configured to stabilize the game collection and retention assembly in a substantially upright position. The first plate is positioned along the support portion of the pole, wherein: the first plate comprises a plurality of teeth projecting from a base of the first plate; and the plurality of teeth at least partially defining five or more notches which are spaced around a perimeter of the first plate. The second plate is positioned along the support portion of the pole at a position superior to the first plate. The third plate is positioned along the support portion of the pole at a position superior to the second plate, the third plate comprising at least one aperture therethrough.

According to another embodiment, a game collection and retention assembly includes a pole and a first plate. The pole includes a stabilizing portion and a support portion, wherein: each of the stabilizing portion and the support portion comprises a first end and a second end; the first end of the stabilizing portion is configured to couple to the second end of the support portion; the second end of the stabilizing portion being configured to stabilize the assembly in a substantially upright position. The first plate is configured to couple to the collapsible pole and includes five or more teeth positioned along an outer perimeter of the first plate. The five or more teeth at least partially define five or more notches.

According to yet another embodiment, a game collection and retention apparatus includes a pole and a first plate. The pole includes a stabilizing portion and a support portion, wherein the stabilizing portion is configured to stabilize the game collection and retention apparatus in a substantially upright position. The first plate is positioned along the support portion of the pole and includes comprising a plurality of teeth around a perimeter thereof, wherein the plurality of teeth at least partially define one or more notches.

Technical advantages of certain embodiments may include efficiently evaluating or otherwise tracking bag limits while hunting. Additionally, certain embodiments may provide organization to a hunt site by providing accommodations for an outdoorsman's gear. Another technical advantage of certain embodiments includes providing an elevated support and retention system which protects harvested game from insects or other predators. Other technical advantages will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 illustrates a particular embodiment of a game collection and retention apparatus being utilized in a manner described herein;

FIG. 2 illustrates the game collection and retention apparatus of FIG. 1;

FIG. 3 illustrates a close-up perspective view of an embodiment of a game collection and retention assembly, according to one embodiment;

FIG. 4 illustrates the game collection and retention assembly of FIG. 3;

FIG. 5A illustrates a game collection and retention assembly comprising an arm brace, according to certain embodiments;

FIG. 5B illustrates the arm brace of FIG. 5A;

FIG. 6A illustrates a game collection and retention assembly comprising an arm brace, according to another embodiment; and

FIG. 6B illustrates the arm brace of FIG. 6A.

### DETAILED DESCRIPTION OF THE DISCLOSURE

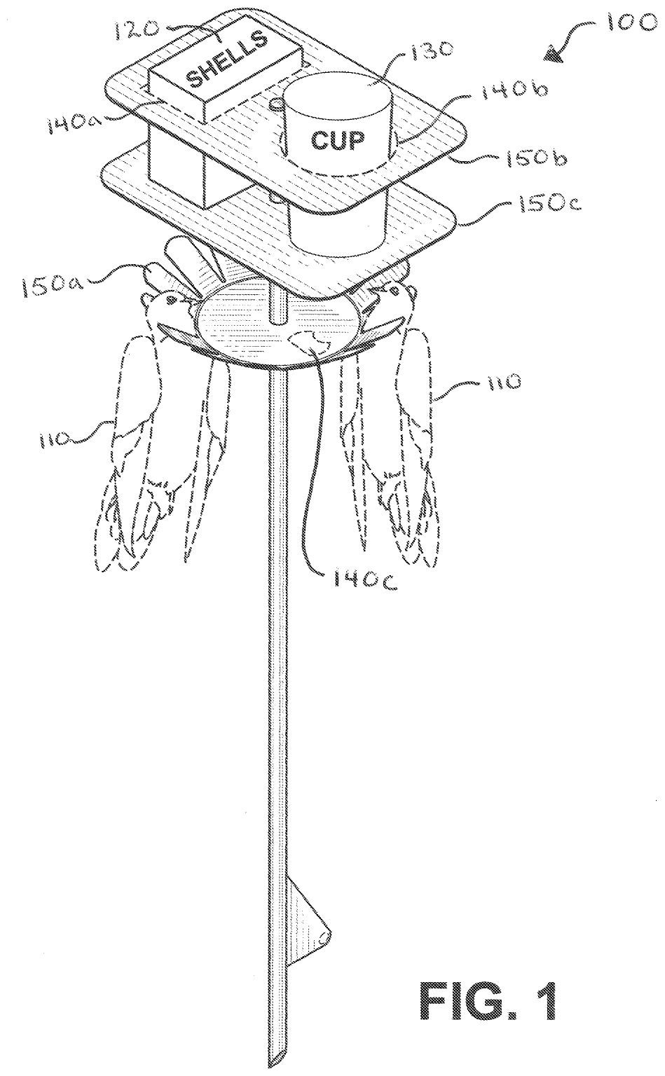

To facilitate a better understanding of the present disclosure, the following examples of certain embodiments are given. The following examples are not to be read to limit or define the scope of the disclosure. Embodiments of the present disclosure and its advantages are best understood by referring to FIGS. 1 through 6B, where like numbers are used to indicate like and corresponding parts.

This disclosure recognizes a game collection and retention system and apparatus that eliminates or reduces the common hunting frustration of monitoring game limits. Conventional methods of monitoring game limits generally require a shift in focus which is disruptive to outdoorsmen actively engaged in the sport of hunting. Indeed, without a game collection and retention system and apparatus as described herein, hunters must either keep an ongoing tally of their takes (e.g., mentally or written) or count and recount their takes during a hunt. The concentration needed to conventionally monitor game limits may—at least temporarily—prevent an outdoorsman from observing his environment and thus can result in missed opportunities to harvest game.

Although mental concentration and time are premium concerns for outdoorsmen, so to is the quality of the harvested game. In many cases, however, outdoorsmen must choose between safeguarding harvested game and spending excessive time monitoring game limits. For example, some hunters may choose to keep harvested game in pouches or pockets located on their person while others may choose to spread their harvested game on the ground by their feet. For those hunters retaining game on their person, keeping track of their bag limit commonly requires removal of harvested game from pouches/pockets which comparatively takes more time to count than if harvested game was spread across the ground and did not need to be removed from pouches/pockets. Collecting harvested game on the ground also has its drawbacks. For example, harvested game typically attracts insects or other predators which, if retained in a way that is easily accessible to those animals, may result in spoliation of the harvested game. The game collection and retention system and apparatus described herein addresses both the spoliation and attention-related concerns by retaining harvested game away from the ground in a manner which permits an outdoorsman to immediately recognize whether his bag limit has been realized.

For similar time and concentration-related reasons, accessibility to other hunting gear and accessories is beneficial. The disclosed game collection and retention system and apparatus provides various support structures to accommodate such gear (e.g., ammunition) and therefore provides other recognizable efficiency benefits to outdoorsman.

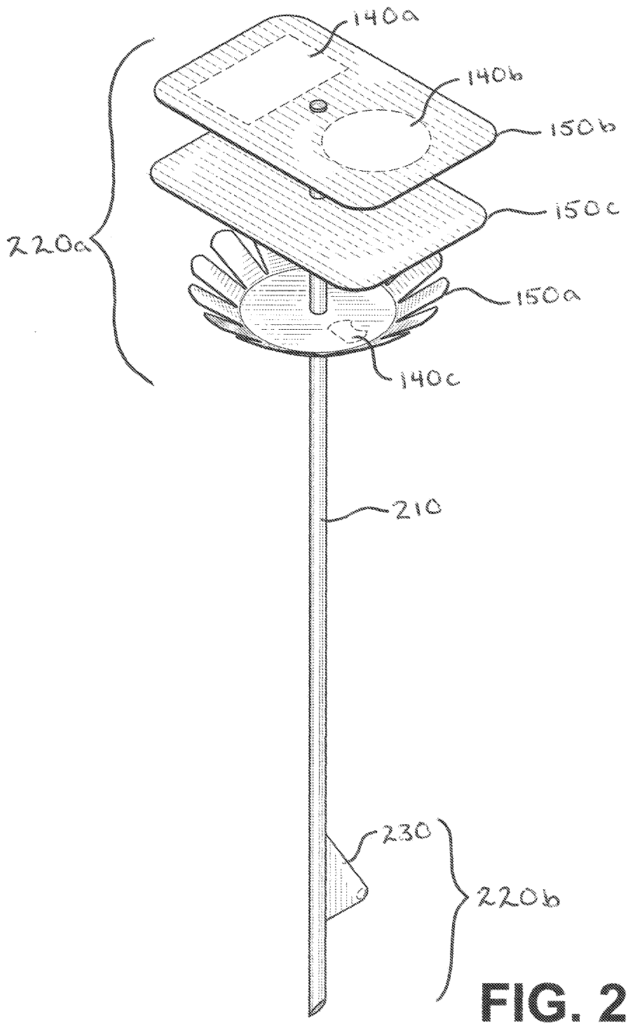

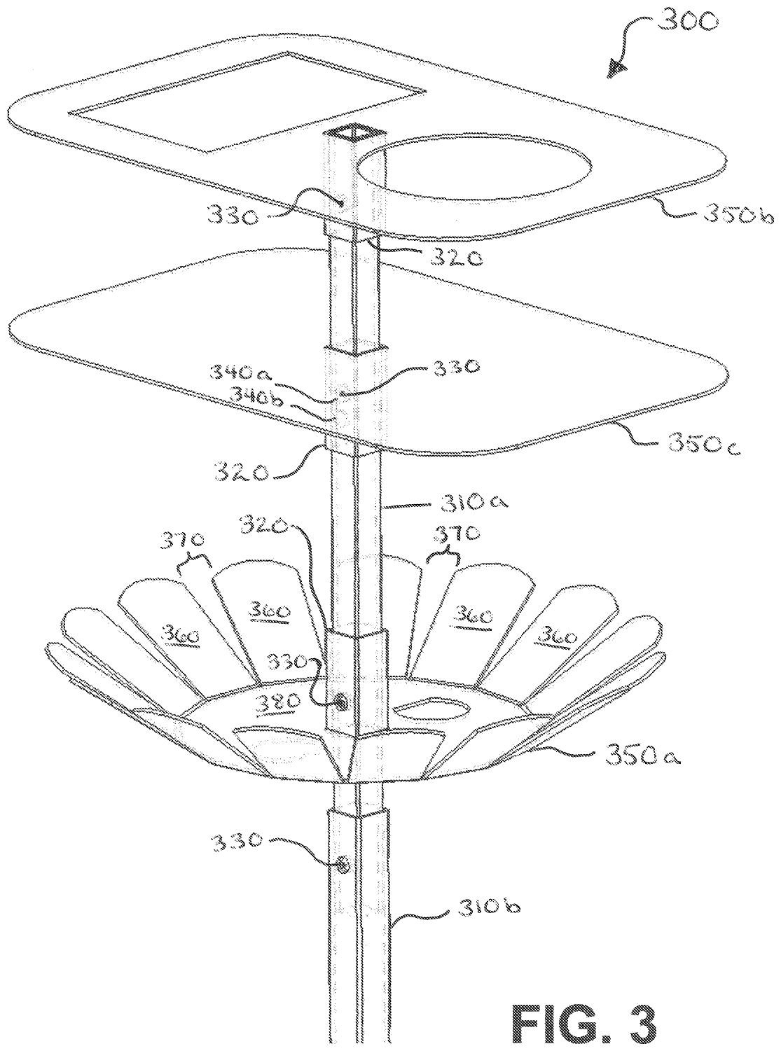

FIGS. 1 and 2 illustrate an exemplary embodiment of a game collection and retention apparatus 100. Apparatus 100 is primarily configured to collect and retain harvested game 110, however, apparatus 100 may be optionally configured to further accommodate hunting gear and accessories. As shown in FIGS. 1 and 2, apparatus 100 includes three plates 150: collection plate 150a, gear plate 150b, and support plate 150c. As will be described in more detail in reference to FIG. 3, collection plate 150a comprises a plurality of teeth which at least partially define a plurality of notches that are configured to accommodate harvested game 110. Gear plate 150a comprises one or more apertures 140 which are sized appropriately to accommodate gear and accessories. As shown in FIGS. 1, gear plate 150a comprises apertures 140a and 140b which are sized to accommodate ammunition 120 and drink receptacle 130, respectively. As an example, aperture 140a may have a width between 2 and 6 inches and a height between 2 and 4 inches. As another example, the circumference of aperture 140b may be between 4 inches and 10 inches. Support plate 150c is configured to provide support to gear and accessories accommodated by apertures 140 formed within gear plate 150b. In some embodiments, the distance between support plate 150c and gear plate 150b is five inches or less.

Although FIG. 1 depicts apparatus 100 as including apertures 140 sized to accommodate particular gear and accessories (i.e., ammunition 120 and drinking receptacle 130), this disclosure recognizes that apparatus 100 may include apertures sized to accommodate any desirable gear and accessories. For example, apparatus 100 may further include an aperture 140 sized to accommodate a mobile device such as a phone or tablet.

Although this disclosure describes and depicts apparatus 100 including three plates 150, this disclosure recognizes that other embodiments of apparatus 100 may include more or less than three plates. For example, this disclosure expressly recognizes embodiments of apparatus 100 wherein apparatus 100 includes only collection plate 150a. Other embodiments may include two plates 150. One such example is an apparatus 100 including collection plate 150a and gear plate 150b. In such embodiment, gear plate 150b may be positioned above collection plate 150a and collection plate 150a may serve as support for gear and accessories accommodated by apertures 140 within gear plate 150b. Additionally, although this disclosure depicts gear plate 150b and support plate 150c as being substantially flat, this disclosure recognizes that one or more of gear plate 150b and support plate 150c may have flanged or angled edges such as to resemble or be trays.

In some embodiments, apparatus 100 may further include one or more utility tools such as bottle opener 140c. This disclosure recognizes that utility tools may be stamped out of one or more plates 150 of apparatus 100 (such as aperture 140c) or may be formed of or added to one or more plates 150 of apparatus 100.

FIG. 2 illustrates apparatus 100 alone (omitting harvested game 110, ammunition 120 and drinking receptacle 130 illustrated in FIG. 1). As depicted, apparatus 100 includes pole 210 in addition to plate(s) 150. In some embodiments, pole 210 comprises a single rod along which plate(s) 150 are welded. In other embodiments, pole 210 comprises multiple subparts that are removably coupled together in a manner that accommodates plates 150. As an example, pole 210 may comprise two or more sections which may be screwed together to accommodate plates 150 (e.g., using threaded rods, nuts and bolts). FIG. 3 illustrates a particular embodiment wherein pole 310 comprises multiple telescoping rods and connectors 320 that couple together with depressible pins 330. Connectors 320 may, in some embodiments, be welded (or otherwise coupled) to the base or top of plates 150. Although this disclosure describes and depicts particular embodiments of pole 210, this disclosure recognizes that pole 210 may take any suitable form that allows for the coupling of plate(s) 150.

As shown in FIG. 2, pole 210 comprises a support portion 220a and a stabilizing portion 220b. Support portion 220a is positioned at a superior end of pole 210 and is configured to support one or more plates 150 in a stacked assembly. In some embodiments, support portion 220a of pole 210 is configured such that equal spacing is provided between each plate 150. In other embodiments, support portion 220a of pole 210 is configured to provide unequal spacing between each plate 150.

In some embodiments, pole 210 is configured such that the position of plates 150 may be adjusted along support portion 210. This adjustability feature may be beneficial, for example, to provide better access or stability to gear, accessories, and/or harvested game 110. As shown in FIG. 3, adjustability of plates 150 may be facilitated by way of using depressible pins 330 that engage apertures within connectors 320. Connectors 320 may include one or more apertures 340 which permits plates 150 to be moved up or down along pole 210. As an example, plate 350c may be in a raised position (i.e., closer to plate 350b) when depressible pin 330 engages aperture 340b and plate 350c may be in a lowered position (i.e., closer to plate 350a) when depressible pin 330 engages aperture 340a.

As described above, pole 210 also includes stabilizing portion 220b. Stabilizing portion 220b is positioned at an inferior end of pole 210 and is configured to stabilize apparatus 100 in an upright position (as illustrated in FIGS. 1-5A & 6A). The embodiments depicted in FIGS. 1, 2 and 4 are intended to stabilize apparatus 100 relative to the ground. Accordingly, this disclosure recognizes stabilizing portion 220b of apparatus 100 including one or more features that facilitate ground penetration or stabilization upon the ground. As one example, stabilizing portion 220b of pole 210 may include a beveled edge. As another example, stabilizing portion 220b of pole 210 may be or comprise two or more fold out stabilizing legs.

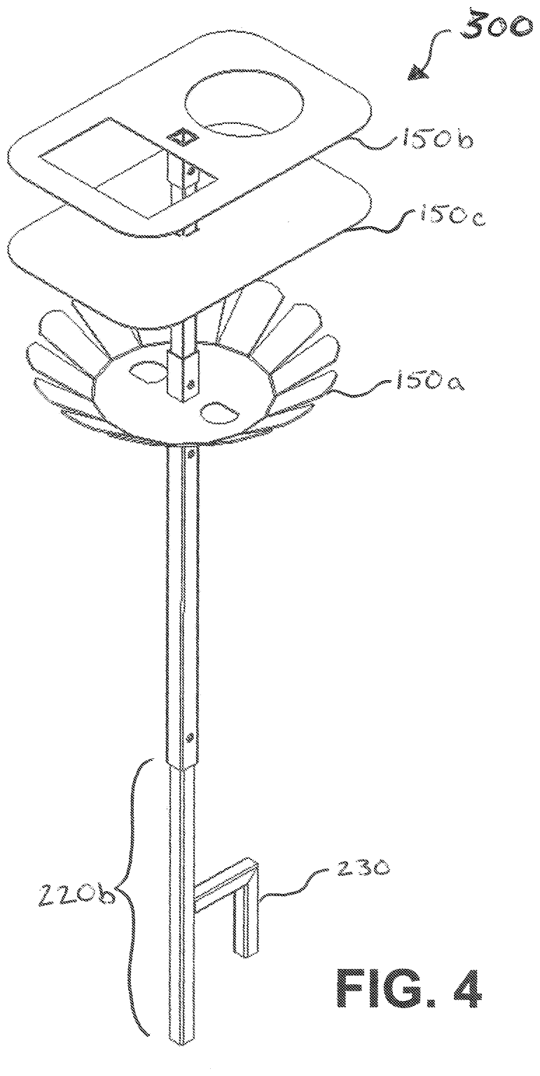

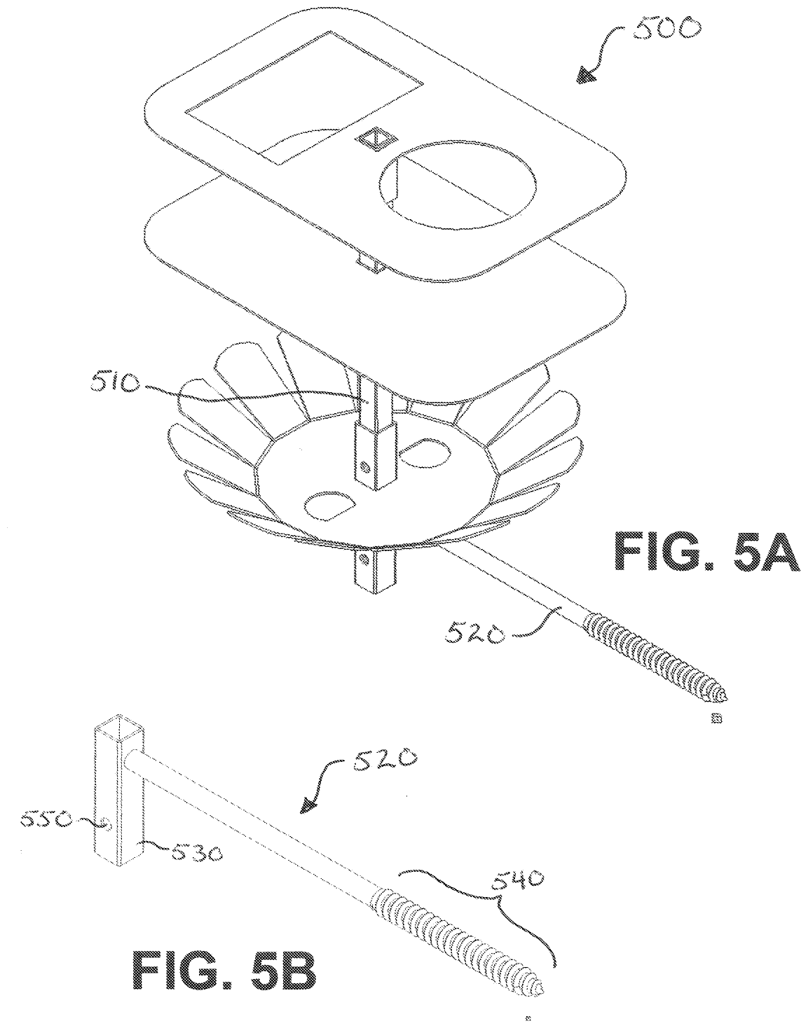

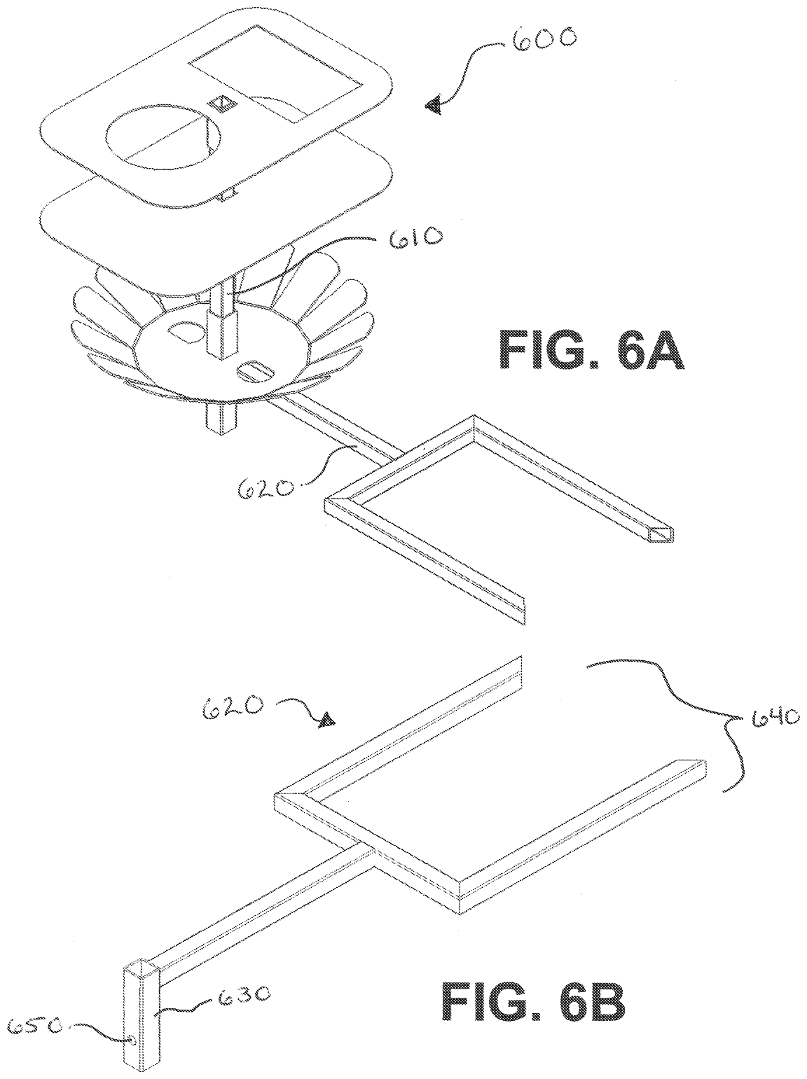

In some embodiments, a ground driver 230 extends from the stabilizing portion 220b of apparatus 100. Ground driver 230 is configured to penetrate the ground and provide stability to apparatus 100. Ground driver 230 may take any suitable size and shape. As depicted in FIGURES and 2, ground driver 230 is a triangularly shaped kickplate. One or more edges of such kickplate may be specially configured to slice or pierce through hard ground (e.g., clay or hardened mud). As shown in FIG. 4, ground driver 230 is an elbow brace comprising a substantially horizontal portion and a substantially vertical portion. This disclosure recognizes certain benefits of using an elbow brace as a ground driver. For example, an outdoorsman may step on or strike (e.g., with a hammer) the substantially horizontal portion of the elbow brace in order to penetrate the ground more easily than driving it into the ground with sheer arm strength. As will be discussed in more detail below with respect to FIGS. 5 and 6, game collection and retention apparatus may be used for other hunting applications where ground is not easily accessible or penetrable.

FIG. 3 illustrates a collapsible embodiment of game collection and retention apparatus 300. Apparatus 300 includes pole 310. As shown in FIG. 3, pole 310 includes a plurality of sections (see 310a & 310b) configured to removably couple to one or more connectors 320 using depressible pins 330. Apparatus 300 further includes a plurality of plates 350. As shown in FIG. 3, apparatus 300 includes collection plate 350a, gear plate 350b, and support plate 350c. Plates 350 are similar in shape and substance to similarly named and numerically referenced plates 150 described above in reference to FIGS. 1 and 2.

Like collection plate 150, collection plate 350 comprises a plurality of teeth 360 which at least partially define a plurality of notches 370 configured to accommodate harvested game 110. Teeth 360 may be positioned along a perimeter of collection plate 150. As shown in FIG. 3, teeth 360 may extend or project from a base 380 of collection plate 350. In some embodiments, base 380 may have one or more apertures therethrough. In other embodiments, base 380 is solid (i.e., contains no apertures) and serves as a resting or support surface for objects and accessories.

In particular embodiments, collection plate 350 includes fifteen notches 370 at least partially defined by fifteen teeth 360. Such embodiment may be beneficial for hunting on occasions when the daily bag limit for a particular type of game is fifteen. In other embodiments, collection plate 350 includes six notches 370 at least partially defined by six teeth 360. Such embodiment may be beneficial for hunting on occasions when the daily bag limit for a particular type of game is six. Although this disclosure describes and depicts collection plate 350 as having particular numbers of teeth 360 and notches 370, this disclosure recognizes that collection plate 350 may have any desired number of teeth 360 and/or notches 370. At a minimum, however, collection plate 350 includes at least two teeth 360 which at least partially define one notch 370.

This disclosure recognizes that a user of apparatus 300 may find it beneficial to own more than one collection plate 350 and either add or swap them out as desired. For example, a user may find it beneficial to own a collection plate comprising notches corresponding to a state bag limit for duck hunting (e.g., six notches) and own a separate collection plate comprising notches corresponding to a state bag limit for dove hunting (e.g., twelve notches).

The size and shape of notches 370 may be dependent on various characteristics of teeth 360. For example, as shown in FIG. 3, notches 370 taper to a point at base 380 of collection plate 350a. This disclosure recognizes certain advantages of tapering the width of notches 370. As an example, tapering the width of notches 370 may allow for the retention and storage of a wider variety of harvested game despite differences in their sizes. As another example, tapering the width of notches 370 may provide the option to hang harvested game by their feet or head.

This disclosure additionally recognizes that one or more blocking devices (not illustrated) can be removably added to collection plate 350 in a manner that prevents the retention of harvested game within a particular notch 370. Blocking devices may be beneficial, for example, in the event that the daily bag limit is decreased and/or the outdoorsman has partially met the daily bag limit earlier in the day and subsequently removed the harvested game from apparatus 300.

As discussed above, game collection and retention apparatus may be used for other hunting applications where ground is not easily accessible or penetrable. For such applications, stabilizing portion 220b may instead feature an arm brace configured to extend from pole 210. FIGS. 5A and 6A illustrate particular embodiments of game collection and retention apparatus comprising arm braces. FIGS. 5B and 6B illustrate exemplary embodiments of arm braces configured to extend from pole 210 of game collection and retention apparatus.

FIG. 5A illustrates a game collection and retention apparatus 500 comprising arm brace 520. As depicted, arm brace 520 may be configured to couple at a first end to pole 510 of apparatus 500. In preferred embodiments, arm brace 520 is removably coupled to pole 510 such that it can be easily removed when undesirable or unnecessary. FIG. 5B illustrates a particular embodiment of arm brace 520 wherein arm brace 520 is welded to a connector 530. As will be understood by one of ordinary skill in the art, arm brace 520 is configured to couple to pole 510 via depressible pins such as those depicted in FIG. 3. Specifically, arm brace 520 may couple to pole 510 by engaging aperture 550 with depressible pin 330.

Arm brace 520 is further configured to include a mounting mechanism 540 at an end opposite the first end. As depicted in FIGS. 5A & 5B, mounting mechanism 540 is a screw thread. A screw thread may be a preferred mounting mechanism 540 in applications wherein a hunting site includes a penetrable structure capable of bearing weight. In such case, screw thread may be screwed into such structure until game collection and retention apparatus 500 is stabilized in an upright position. A screw thread may be a particularly effective mounting mechanism 540 for stabilizing apparatus 500 in an appropriately sized stem, stalk, and/or tree trunk.

FIG. 6A illustrates a game collection and retention apparatus 600 comprising arm brace 620. As depicted, arm brace 620 may be configured to couple at a first end to pole 610 of apparatus 600. In preferred embodiments, arm brace 620 is removably coupled to pole 510 such that it can be easily removed when undesirable or unnecessary. FIG. 6B illustrates a particular embodiment of arm brace 620 wherein arm brace 620 is welded to a connector 630. As will be understood by one of ordinary skill in the art, arm brace 620 is configured to couple to pole 610 via depressible pins such as those depicted in FIG. 3. Specifically, arm brace 620 may couple to pole 610 by engaging aperture 650 with depressible pin 330.

Arm brace 620 is further configured to include a mounting mechanism 640 at an end opposite the first end. As depicted in FIGS. 6A & 6B, mounting mechanism 640 is a mounting fork. A mounting fork may be a preferred mounting mechanism 640 in applications wherein a hunting site includes a penetrable structure capable of bearing weight. In such case, mounting fork may be pressed into, or otherwise pierce, such structure until game collection and retention apparatus 600 is stabilized in an upright position. A mounting fork may be a particularly effective mounting mechanism 640 for stabilizing apparatus 600 in a hay bail.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A game collection and retention apparatus comprising:
a pole comprising a stabilizing portion and a support portion, wherein:
each of the stabilizing portion and the support portion comprises a first end and a second end;
the first end of the stabilizing portion is configured to couple to the second end of the support portion; and
the second end of the stabilizing portion is configured to stabilize the game collection and retention assembly in a substantially upright position;
a first plate positioned along the support portion of the pole, wherein:
the first plate comprises a plurality of teeth projecting from a base of the first plate; and
the plurality of teeth at least partially defining five or more notches which are spaced around a perimeter of the first plate;
a second plate positioned along the support portion of the pole at a position superior to the first plate; and
a third plate positioned along the support portion of the pole at a position superior to the second plate, the third plate comprising at least one aperture therethrough.

2. A game collection and retention assembly comprising:
a pole comprising a stabilizing portion and a support portion, wherein:
each of the stabilizing portion and the support portion comprises a first end and a second end;
the first end of the stabilizing portion is configured to couple to the second end of the support portion;
the second end of the stabilizing portion being configured to stabilize the assembly in a substantially upright position; and
a first plate configured to couple to the collapsible pole, the first plate comprising five or more teeth positioned along an outer perimeter of the first plate, the five or more teeth at least partially defining five or more notches.

3. The assembly of claim 2, wherein the pole may be collapsible.

4. The assembly of claim 2, further comprising one or more additional plates configured to couple to the pole.

5. The assembly of claim 2, wherein the stabilizing portion further comprises a ground driver.

6. The assembly of claim 2, wherein the pole comprises one or more telescoping rods.

7. The assembly of claim 2, wherein the pole comprises one or more sections configured to be coupled together with one or more depressible push buttons.

8. The assembly of claim 2, wherein the stabilizing portion comprises an arm brace.

9. The assembly of claim 2, wherein the plurality of notches are equally spaced around the perimeter of the first plate.

10. The assembly of claim 2, wherein the first plate comprises fifteen notches.

11. The assembly of claim 2, wherein the first plate comprises at least fifteen teeth.

12. The assembly of claim 2, wherein each notch has a tapering width.

13. A game collection and retention apparatus comprising:
a pole comprising a stabilizing portion and a support portion, the stabilizing portion being configured to stabilize the game collection and retention apparatus in a substantially upright position; and
a first plate positioned along the support portion of the pole, the first plate comprising a plurality of teeth around a perimeter thereof, the plurality of teeth at least partially defining one or more notches.

14. The game collection and retention apparatus of claim 13, wherein the plurality of teeth are spaced around the perimeter of the first plate.

15. The game collection and retention apparatus of claim 13, wherein each of the one or more notches has a tapering width.

16. The game collection and retention apparatus of claim 13, wherein each tooth of the plurality of teeth projects from an inner portion of the first plate at an upward angle.

17. The game collection and retention apparatus of claim 13, wherein the stabilizing portion further comprises an arm brace.

18. The game collection and retention apparatus of claim 13, wherein the stabilizing portion further comprises a ground driver.

19. The game collection and retention apparatus of claim 13, wherein the pole is collapsible.

20. The game collection and retention apparatus of claim 13, further comprising a second plate positioned along the support portion of the pole.
